(19) United States
(12) Patent Application Publication
(10) Pub. No.: US 2003/0229945 A1
(43) Pub. Date: Dec. 18, 2003

(54) Combination tool for installing landscape edging strips

(76) Inventor: Ronald W. McAbee, Greenville, TX (US)

Correspondence Address: Charles W. McHugh, 1010 Milby Road, Arlington, TX, 76013, US

(21) Appl. No.: 10/174,433

(22) Filed: Jun. 17, 2002

(51) Int. Cl. B25D 1/04

(52) U.S. Cl. 7/144

(57) ABSTRACT

A hand-tool having the general configuration of a hammer, with a head and an elongated handle. The head is mounted at one end of the handle. The head has two oppositely directed faces which are alternately used. One face is similar to that of a conventional hammer that is used to deliver impact blows to drive a stake into the ground. The other face has a central groove that is sized to slip over and engage a stake in such a way that leverage applied to the handle (in a transverse diction) will sate the stake enough as to cause it to be broken away from a Landscape Edging Strip of the type shown in U.S. Pat. No. 6,345,465.

### FIELD OF THE INVENTION

This invention relates generally to the installation of elongated strips of material that are commonly used as landscape edging, and particularly those strips that are shown in U.S. Pat. No. 6,345,465 to Allen and Glassel entitled “Landscape Edging System With Stakes Attached”; more specifically, the invention relates to a combination tool that is capable of delivering hammer-like blows for driving stakes into the ground, as well as a leverage tool for breaking the stakes away from the edging strips to which they are attached during shipping to a retailer

### BACKGROUND OF THE INVENTION

A popular item for landscaping and lawn maintenance are elongaged strips that serve as dividing barriers between varied parts of a lawn, etc. A popular product is a steel strip that is manufactured and marketed by Collier Metal Specialties of Garland, Tex. under the trademark “COL-MET”. These metal strips are fully disclosed in U.S. Pat. No. 6,345,465 to Allen and Glassel entitled “Landscape Edging System With Stakes Attached”. To ship these steel strips from the factory to dealers, they are sometimes bound together with a few generally square loops of a reinforced plastic material, which hereinafter will be called holders. The holders do a good job of holding a plurality of strips together during shipment and storage; but their servicable life must eventually come to a proper end. That is, when the time comes to handle individual strips and/or install them, the plastic holder must necessarily be broken.

Regretably, the holders have been designed for strength and integrity, and no thought has apparently been given to how they might be safely broken when their design life is at an end. In practice, workers have commonly used ordinary claw hammers to beat on the plastic holders until they break. This practice has proven to be hazardous, because particles of the plastic holders have often bounced around in a random manner—when the holders break, sometimes hitting the worker who is swinging the hammer, and sometimes hitting others who are merely standing nearby.

As an alternative to beating on a plastic holder with a hammer, the invention disclosed herein can be used to gently apply a bending load on the plastic holder until it breaks. Engagement of the disclosed tool is accomplished by placing an elongated groove in the head of the tool over an exposed edge of a plastic holder. Then, pushing the handle in a transverse direction, i.e., a direction that is perpendicular to the plane in which the plastic holder rests, the tool's head is caused to slowly rotate (with the handle) until the plastic holder (embraced by the elongated groove) is subjected to enough torsion loading so that the holder breaks.

Another way in which the edging strips are shipped is to place a hundred or more of them in a specially-made shipping container, and ship the container from the factory to a retailer—where individual strips are then transferred to customers. But, as disclosed in the Allen and Glassel '465 patent, it might be said, “Some assembly is required.” More precisely, it should probably be said, “Some disassembly is required.” That is, the stakes that are manufactured as an integral part of an elongated piece of edging must be broken away from the edging in order to render the stakes usable for anchoring the edging to the ground. Both the '465 patent and the instruction sheet for customers suggest a pair of locking pliers for this job, while a large hammer is recommended for subsequently driving the stakes into the ground.

In accordance with this invention, a double-ended tool having the general configuration of a hammer is provided, with one end being used as an impact tool for driving stakes into the ground, and the other end having a pair of differently sized grooves. The larger of the two grooves is sized to easily slip over the plastic shipping holder (when used) in order to apply a fracturing force to the holder. The more narrow of the two grooves is sized to slip easily over an exposed edge of a stake while the stake is still attached to a piece of the edging. Applying a bending force to the tool's handle will then cause the stake to bend with respect to the much heavier piece of edging until the “breakable tabs” that hold the stake in place are broken. After the first (or outermost) stake is broken free, the second (or innermost) stake is exposed so that it can be broken off the piece of edging in a similar manner. When all of the stakes are broken free, they are ready to be individually placed in the “pockets” associated with the edging pieces—and driven into the ground, thereby holding the edging strips in desired locations.

### DETAILED DESCRIPTION OF A PREFERRED EMBODIMENT OF THE INVENTION

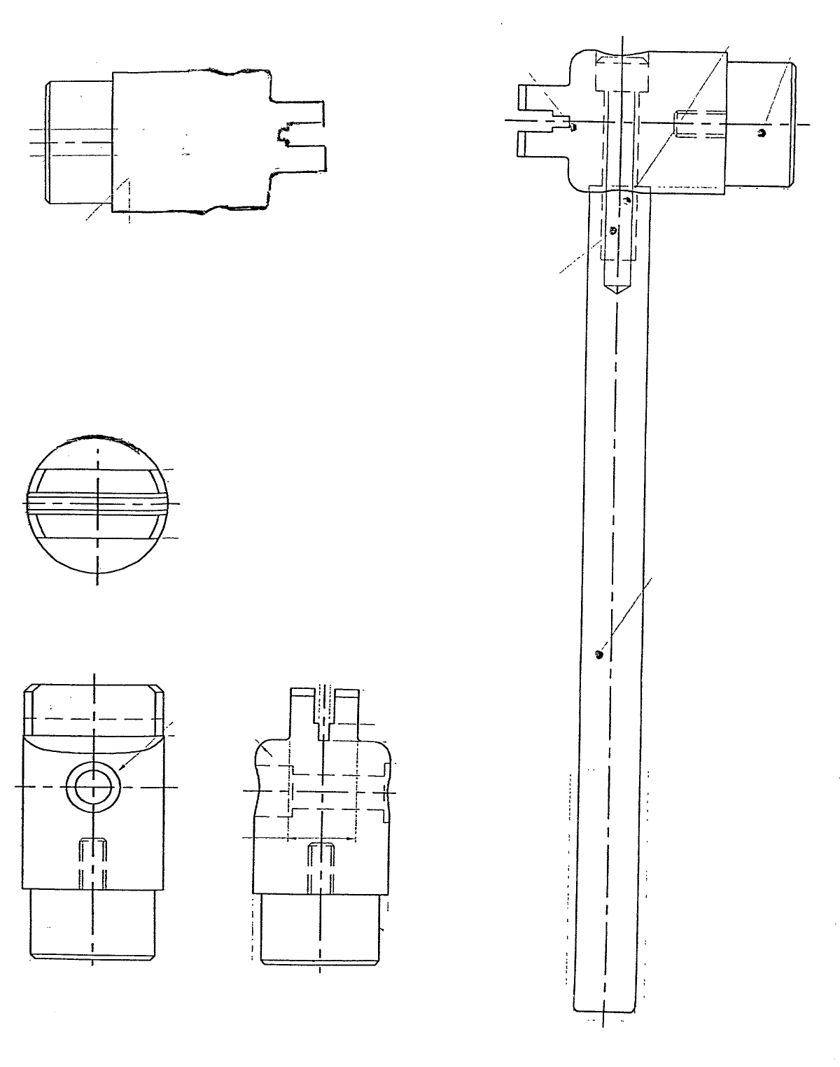

Referring initially to FIG. 1 of the drawing, the head 12 of the combination tool 10 is shown from one side, with the impact element 14 to the right and the grooved end 16 to the left. The head 12 may also be described as an elongated, generally cylindrical body 18 having a longitudinal axis 20 extending from one end to the other. The head's weight is preferably about one pound, and it is mounted at the top of a handle 22 which has a length of about one foot and a weight of about one pound. The impact element 14 is preferably made of hard rubber, and it is preferably attached to the elongated body 18 with a threaded element (e.g., a bolt) so that the element may be selectively removed and replaced if its face becomes marred from excessive use. A 7/16-14 NC threaded stud has been found to be quite satisfactory for mounting the impact element 14 to the elongated body.

The wide groove 30 in the head's second end 16 preferably has a width of about 0.212 inch and a depth (measured along the longitudinal axis of the head) of about one-half inch. It has been found that this one-half inch distance is quite adequate to envelop an exposed edge of a plastic holding member that has often been used to ship a “bundle” of ten of the edging strips. When the groove 30 is engaged with an outer edge of the holding member, and a transverse force is manually applied to the handle, it is relatively easy to twist the holding member so that it will fracture in a “controlled” manner, i.e., without sending plastic fragments with an explosive force in random or unexpected directions.

The narrow groove 32 is preferably about 0.158 inch wide and about ¾ inch deep, and it is also centered with respect to the body 18. The function of the narrow groove 32 is to envelop an exposed edge of a stake while the stake is still firmly secured to its associated piece of landscape edging. A transverse force applied to the handle 22 can readily produce the bending moment that is needed to break the metal “tabs” that hold a stake to its associated landscaping strip. And once the outermost stake as been broken loose, the innermost stake is exposed so it too may be broken loose by the tool 10.

While the tool 10 may be accurately thought of as a special-purpose tool for getting certain edging ready for installation, as well as for assisting in the installation of stakes that will hold the edging in place, a used tool need not be thrown to the rear of a tool shed—where it may or may not ever be thought of again. The hard rubber material on what may be considered to be the forward end of the tool can be used as a non-marring impact element for seating wheel covers on automobiles, etc. And, if the hardness of the impact end is not exactly what seems to be desirable, the threaded connection will permit an exchange with an impact element of a different hardness.

What is claimed is:

1. A tool for applying a bending load to a plastic holder that is performing its intended function of binding together a plurality of steel landscaping strips, said bending load being applied for the purpose of safely breaking the plastic holder, and said plastic holder having the general shape of a rectangular loop and having an exposed edge that protrudes above the plurality of side-by-side landscaping strips that are being held together for storage and transportation, comprising:
a) a head having an open groove that is sized to slip over and encompass the exposed edge of a plastic holder while the plastic holder is surrounding a plurality of steel landscaping strips, and said open groove being generally defined by a central plane; and
b) a rigid handle attached to the head with an orientation so that the handle is generally perpendicular to the open groove in the head, and the handle being further oriented so that a manual force can be applied to the handle in a direction that is generally perpendicular to the central plane of the head's groove, whereby a manual force applied transversely to the handle will apply a bending force on the plastic holder that is being held in a static manner by the plurality of landscaping strips, and whereby a bending force on the plastic holder can be made to fracture the holder.

2. The tool as claimed in claim 1 wherein the handle is rigidly attached to the head with a threaded member so as to be carried with the head at all times.

3. The tool as claimed in claim 1 wherein the length of the handle is about twelve inches and it weighs about one pound.

4. The tool as claimed in claim 1 and including a second groove in the head that is oriented so as to be genarally parallel to the first groove but being located on the same face of the head as the first groove.

5. A combination tool for use in installing landscaping strips, said strips being generally planar and being manufactured with stakes rigidly connected thereto, the tool having a head with first and second ends, and the tool having a handle connected to the head between the two ends thereof, comprising:
a) an impact element attached to a first end of the head for applying vertical blows to the top of a stake for driving the stake into the ground; and
b) an outwardly facing groove in the second end of the head, said groove being sufficiently wide as to encompass an edge of the stake while the stake is still attached to the landscaping strip, and the groove being sufficiently deep as apply a bending load to a stake when the tool's handle is moved in a plane that is perpendicular to the plane of the landscaping strip.

6. The combination as claimed in claim 5 wherein the impact element is attached to the head with a threaded member so that the impact element may be selectively removed and replaced.
